SEQUENCE LISTING (4 sequences)

SEQ ID NO: 1 - protein, 4 aa, Artificial Sequence
  Description of Artificial Sequence synthetic peptide
SGEP

SEQ ID NO: 2 - protein, 4 aa, Artificial Sequence
  Description of Artificial Sequence synthetic peptide
TTEA

SEQ ID NO: 3 - protein, 4 aa, Artificial Sequence
  Description of Artificial Sequence synthetic peptide
FLEP

SEQ ID NO: 4 - protein, 4 aa, Artificial Sequence
  Description of Artificial Sequence synthetic peptide
FLQP

(19) United States
(12) Patent Application Publication
(10) Pub. No.: US 2009/0081329 A1
(43) Pub. Date: Mar. 26, 2009

(54) Method for Producing Cheese Using Heat Treated Milk and a Protein Hydrolysate

(75) Inventors: Albertus Alard Van Dijk, Vlaardingen (NL); Baukje Folkertsma, Delft (NL); Lambertus Jacobus Otto Guillonard, Den Haag (NL)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., Heerlen (NL)

(21) Appl. No.: 11/793,725

(22) PCT Filed: Dec. 21, 2005
(86) PCT No.: PCT/EP2005/057038

§ 371 Date: Jun. 21, 2007

(30) Foreign Application Priority Data
Dec. 23, 2004 (EP) 04106961.8

(51) Int. Cl. A23C 19/02; A23C 19/00

(52) U.S. Cl. 426/40; 426/582

(57) ABSTRACT

The present invention describes a method of producing curd or cheese from a milk composition consisting of the following steps:—heating the milk, —adding to the heat treated milk a protein hydrolysate, —adding to the heat treated milk a coagulant to form a gel, and—processing the formed gel into a cheese curd and separating the whey from the curd.

### FIELD OF THE INVENTION

The invention relates to a method of producing cheese.

### BACKGROUND OF THE INVENTION

Coagulation is an essential step in the traditional production of cheese from a dairy composition such as bovine milk.

The coagulation may be started by acidification and/or the addition of an enzyme (coagulant) such as chymosine. After coagulation, the milk is separated into curd and whey. The curd is processed further into cheese. Caseins form the main protein component of the curd, and since cheese is a more valuable product than whey there is a desire to maximize the amount of protein incorporated into the curd. The inclusion of whey proteins into the curd would lead to an increase in cheese yield (=kg cheese produced from 1 L cheese milk), which is desirable.

Cheese manufacturing processes from various milk sources have long been known and have been described in detail for many different types of cheese variants. (see e.g. Cheese: Chemistry, Physics and Microbiology, Vol 1&2, 1999, Ed. Fox, Aspen Publications, Gaithersburg, Md.; Encyclopedia of Dairy Sciences Vol 1-4, 2003, Academic Press, London). A crucial point in cheese manufacture is the process of coagulation, in which the solubility of the casein micelles and submicelles is decreased. Enzyme induced coagulation is very commonly used. Enzymes like calf chymosine, microbial equivalents of chymosine and other enzymes from other sources have been described and several are available under various trade names. All of them can be used to initiate the coagulation process. The primary step in coagulation is the cleavage of the Phe₁₀₅-Met₁₀₆ bond in κ-casein. This leads to removal of the C-terminal part of K-casein: the glycomacropeptide (GMP). Removal of the GMP leads to association of the casein micelles, i.e casein coagulation. Casein coagulation leads to gel formation, and the time required to obtain gelling in a particular dairy composition is directly related to the activity of the coagulant.

The time that passes between addition of the coagulant and appearance of initial casein flocculation is defined as the coagulation (clotting) time. The speed at which the gel is formed in cheese milk and the compactness of the gel depend closely on the quantity of enzyme added, the concentration of calcium ions, phosphorous, temperature and the pH. After the initial coagulation, a gel is formed and the consistency of the gel increases following an increase in the inter-micellar bonds. The micelles move together and the coagulum contracts, hereby expelling the whey. This phenomenon is known as syneresis and is accelerated by cutting the curd, increasing the temperature and increasing the acidity produced by the developing lactic acid bacteria.

For microbiological safety, cheese milk is heat treated prior to use. Various heat-treatments are used for milk such as thermisation (65° C., few seconds), low pasteurization (72° C., 15 seconds), high pasteurization (85° C., 20 seconds) and ultra high Temperature (UHT) treatment (e.g. 1 second, 145° C.). The heat treatment increases the keeping quality of milk and destroys micro-organisms. Furthermore, for certain dairy applications a particular heat treatment may be required to obtain the desired characteristics of the end product, such as in yogurt-making. Heat treatment may lead to impaired milk properties for cheese making purposes (see e.g. Singh & Waungana, Int Dairy J (2001), 11, 543-551). Heat treatments that lead to impaired milk clotting properties such as increased coagulation time, decreased curd firming rate or decreased curd strength will in the remainder of this text be referred to as ‘high heat treatment’; the resulting milk will be referred to as ‘high heated milk’ throughout this text.

Significant changes occurring upon heating milk above 60° C. include denaturation of whey proteins, interactions between denatured whey proteins and the casein micelles and the conversion of soluble calcium, magnesium and phosphate to the colloidal state. Casein micelles are very stable at high temperatures although changes in zeta-potential, sizem hydration of micelles, as well as some association-dissociation reactions do occur at severe heating temperatures (Singh & Waungana, Int Dairy J (2001) 11, 543-551; and references cited therein). Upon heating milk above 65° C., whey proteins are denatured by the unfolding of their peptides. The unfolded proteins then interact with casein micelles or simply aggregate themselves, involving thiol-disulfide interchange reactions, hydrophobic interactions and ionic linkages. Ionic strength, pH and concentration of calcium and protein influence the extent of denaturation of the whey proteins. Heat denaturation of proteins is also influenced by the presence of lactose and other sugars, polyhydric alcohols and protein modifying agents.

Denatured whey proteins have been shown to associate with κ-casein on the surface of the casein micelles. The principle interaction is considered to be between β-lactoglobulin and κ-casein and involves both disulfide and hydrophobic interactions (Singh and Fox, J Dairy Res (1987) 54, 509-521). Part of the denatured whey proteins does not complex with the casein micelles, but form aggregates with other whey proteins. The extent of association of denatured whey proteins with casein micelles is markedly dependent on the pH of the milk prior to heating, levels of calcium and phosphate, milk solids concentration and type of heating system (water bath, indirect or direct). Indirect heating is reported to result in greater proportions of β-lactoglobulin and a-lactalbumin associating with the micelles compared to the situation where direct heating is used (e.g. steam injection). Heating at pH values less than 6.7 results in a greater quantity of denatured whey proteins associating with the micelles, whereas a higher pH values whey protein/K-casein complexes dissociate from the micelle surface (Singh & Waunanga, Int Dairy J (2001) 11, 543-551).

Heat-treatment results in various changes in the milk. The most obvious change is the partial or full denaturation of whey proteins. The degree of denaturation depends on the heat treatment and the conditions in the milk such as pH and presence of additives like carbohydrates. Heat treatment of milk results in the formation of whey protein aggregates containing both a-lactalbumin and β-lactoglobulin (Singh & Waungana, Int Dairy J (2001), 11, 543-551; Vasbinder, Casein-whey protein interactions in heated milk, Thesis, ISBN 90-393-3194-4). The casein micelle fraction is not noticeably affected in the temperature range 70-100° C. Calcium phosphate, which is also present in the casein micelles, precipitates upon heat treatment and only slowly redissolves after cooling. Heat treatment of milk also results in the interaction of denatured whey proteins with the casein micelles. The interaction may be covalent via disulfide bond formation between e.g. β-lactoglubulin and κ-casein, and these interactions stabilize the casein micelle. The final composition of heat-treated milk depends on the milk pH and the temperature applied. The properties of the heated milk are determined by the final milk composition.

High heated milk shows impaired clotting behavior (Singh & Waungana (2001), Int Dairy J. 11, 543-551). Clotting times are increased and a weaker, finer curd is formed that retains more water than normal. In literature there is controversy about the cause of the increase in clotting time. A generally accepted explanation is that the κ-casein GMP moiety has reacted with β-lactoglobulin, and that this causes steric hindrance for the coagulating enzyme leading to inhibition of the κ-casein cleavage (see e.g. Singh et al (1988) J Dairy Res. 55, 205). The phenomenon of a weaker curd is explained in several ways. One explanation for the weaker curd is that the κ-casein is insufficiently cleaved (see: Walstra & Jennes, (1984) Dairy Chemistry and Physics, John Wiley and sons Inc, USA). Another explanation is that the heat-induced calcium phosphate precipitation is responsible (see e.g. Schreiber (2001) Int. Dairy J. 11, 553). A third explanation is that whey-proteins denature during heat treatment and associate with the casein micelles, thereby interfering with casein micelle-micelle interactions (Vasbinder, Casein-whey protein interactions in heated milk, Thesis, ISBN 90-393-3194-4). It is unclear which of these explanations is the most relevant one.

It is known that the adverse effects of heat treatment on rennet coagulation can be overcome to some extent by either a) decreasing the pH to about 6.2, b) acidifying milk to below 5.5 followed by neutralization to 6.6 or c) adding calcium chloride (Lucey et al (1993) Cheese yield and factors affecting its control, special issue 9402 pp 448-456, International Dairy Federaton). However, these remedies are not satisfactory solutions since the original curd strength and clotting time were not restored. Furthermore, extra handling of the cheese milk in case of pH adjustments is required.

The possibility of using high heated milk for cheese making would be desirable. On the one hand the heat treatment increases the shelf life of the milk, allowing longer transport and storage times. On the other hand it leads to a significant increase in cheese yield. Increases up to 10% or more have been reported. However, factors preventing use of high heated milk are the increased clotting time and increased curd weakness (finer curd that retains more water than normal). Correlated to the curd weakness are increased cheese curd losses during curing and pressing of the cheese. There is an industrial need and desire to solve the drawbacks of high heated milk in cheese production.

### SUMMARY OF THE INVENTION

It has surprisingly been found that the addition of a protein hydrolysate, a peptide or a mixture of peptides to heated milk in a cheese making process results in reduction or elimination of the increase in milk clotting time. Moreover, the addition of a protein hydrolysate, a peptide or a mixture of peptides reduces or eliminates the increased curd weakness that would normally occur in such cases. The present invention relates a method of producing curd or cheese from a milk composition comprising the following steps:

heating milk,

adding to the heat treated milk a protein hydrolysate, and/or a peptide and/or a mixture of peptides

adding to the heat treated milk a coagulant to form a gel, and

processing the formed gel into a cheese curd and separating the whey from the curd.

Therefore, the invention relates to a method of producing cheese, comprising treating cheese milk at an elevated temperature for a sufficient period of time, preferably to cause impaired milk clotting behavior during the coagulation step, adding to the heat-treated cheese milk a protein hydrolysate and/or a peptide and/or mixture of peptides, adding to the heat-treated milk a coagulant to form a gel and processing the formed gel into a cheese curd and separating the whey from the curd. According to the present process a curd is obtained which comprises a hydrolysate and which preferably has a clotting time (r) of 20 mm or less (corresponding to 10 minutes or less), more preferably of 18 mm or less (corresponding to 9 minutes or less) and preferably a curd strength (k20) of 100 mm or less, more preferably of 90 mm or less. The clotting time is measured according to the method of Example 2. The invention also describes the use of a hydrolysate and/or a peptide and/or a mixture of peptides to reduce the clotting time in a cheese making process whereby heat treated milk is used, and the use of a hydrolysate to increase the curd strength of a curd in a cheese making process whereby heat treated milk is used.

Preferably the peptide comprises 2 to 5 amino acids. The peptide mixture comprises at least one peptide which comprises 2 to 5 amino acids. The hydrolysate comprises at least one peptide which comprises 2 to 5 amino acids. Advantageously at least one of amino acids of the peptide is a Glu or Asp residue, or a peptide comprises a Lys-Lys residue, or the peptide is the dipeptide Lys-Lys.

In this text the terms ‘dairy composition’ and ‘milk’ will both be used; milk is considered as an example of a dairy composition herein.

Another aspect of the invention relates to a method of producing cheese, comprising 1) treating cheese milk by heat treatment, 2) adding to the cooled cheese milk a protein hydrolysate and/or a peptide and/or a peptide mixture and 3) producing cheese from said dairy composition.

A further aspect of the invention relates to the cheese produced by the method of the invention.

### DETAILED DESCRIPTION OF THE INVENTION

### Cheese

In the present context, the term ‘cheese’ refers to any kind of cheese such as e.g. natural cheese, cheese analogues and processed cheese. The cheese may be obtained by any suitable process known in the art such as e.g. by enzymatic coagulation of a dairy composition with rennet, or by acidic coagulation of a dairy composition with a food grade acid or acid produced by lactic acid bacteria growth. In one embodiment, the cheese manufactured by the process of the invention is rennet-curd cheese. The dairy composition may be subjected to a conventional cheese-making process.

Processed cheese is preferably manufactured from natural cheese or cheese analogues by cooking and emulsifying the cheese, such as with emulsifying salts (e.g. phosphates and citrate). The process may further include the addition of spices/condiments.

The term ‘cheese analogues’ refers to cheese-like products which contain fat (such as e.g. milk fat (e.g. cream) as part of the composition, and which further contain, as part of the composition, a non-milk constituent, such as e.g. vegetable oil.

The cheese produced by the process of the present invention comprises all varieties of cheese, such as soft cheese, semi-hard cheese and hard cheese. In cheese manufacture, the coagulation of a dairy composition is preferably performed either by rennet or by acidification alone resulting in rennet-curd and acid-curd cheese, respectively. Fresh acid-curd cheeses refer to those varieties of cheese produced by the coagulation of milk, cream or whey via acidification or a combination of acid and heat, and which are ready for consumption once the manufacturing without ripening is completed. Fresh acid-curd cheeses generally differ from rennet-curd cheese varieties (e.g. Camembert, Cheddar, Emmenthal) where coagulation normally is induced by the action of rennet at pH values 6.4-6.6, in that coagulation normally occurs close to the iso-electric point of casein, i.e. e.g. at pH4.6 or at higher values when elevated temperatures are used, e.g. in Ricotta at pH typically about 6.0 and temperature typically about 80° C. In a preferred embodiment of the invention, the cheese belongs to the class of rennet curd cheeses.

Mozzarella is a member of the so-called pasta filata, or stretched curd, cheese which are normally distinguished by a unique plasticizing and kneading treatment of the fresh curd in hot water, which imparts the finished cheese its characteristic fibrous structure and melting and stretching properties. In one embodiment the invention further comprises a heat-stretchin treatment as for pasta filata cheeses, such as for the manufacturing of Mozzarella.

### Dairy Composition

A dairy composition according to the invention may be any composition comprising milk constituents. Milk constituents may be any constituent of milk such as milk fat, milk protein, casein, whey protein and lactose. A milk fraction may be any fraction of milk such as e.g. skim milk, butter milk, whey, cream, milk powder, whole milk powder, skim milk powder. In a preferred embodiment of the invention the dairy composition comprises milk, skim milk, butter milk, whole milk, whey, cream, or any combination thereof. In a more preferred embodiment the dairy composition consists of milk, such as skim milk, whole milk, cream or any combination thereof.

In further embodiments of the invention, the dairy composition is prepared, totally or in part, from dried milk fractions, such as e.g. whole milk powder, skim milk powder, casein, caseinate, total milk protein or buttermilk powder, or any combination thereof.

According to the invention the dairy composition comprises cow's milk and or one or more cow's milk fractions. The cow's milk fractions may be from any breed of cow (Bos Taurus (Bos taurus taurus), Bos indicus (Bos indicus taurus) and crossbreeds of these. In one embodiment the dairy composition comprises cow's milk and/or cow's milk fractions originating from two or more breeds of cows. The dairy composition also comprises milk from other mammals that are used for cheese preparation, such as milk derived from goat, buffalo or camel.

In general the cheese will be made with heat-heated milk according to the present invention. Also milk that contains at least 20 wt %, preferably at least 30 wt %, more preferably at least 50 wt % and most preferably at least 70% wt of heat treated milk and the remainder of milk that is not heat treated according the present meaning.

The dairy composition for production of cheese may be standardized to the desired composition by removal of all or a portion of any of the raw milk components and/or by adding thereto additional amounts of such components. This may be done e.g. by separation of milk into cream and milk upon arrival to the dairy. Thus, the dairy composition may be prepared as done conventionally by fractionating milk and recombining the fractions so as to obtain the desired final composition of the dairy composition. The separation may be made in continuous centrifuges leading to a skim milk fraction with very low fat content (i.e. <0.5%) and cream with e.g. >35% fat. The dairy composition may be prepared by mixing cream and skim milk. In another embodiment the protein and/or casein content may be standardized by the use of ultra filtration. The dairy composition may have any total fat content that is found suitable for the cheese to be produced by the process of the invention.

In one embodiment of the invention, calcium is added to the dairy composition. Calcium may be added to the dairy composition at any appropriate step before and or during cheese making, such as before, simultaneously with, or after addition of starter culture. In a preferred embodiment calcium is added both before and after the heat treatment. Calcium may be added in any suitable form. In a preferred embodiment calcium is added as calcium salt, e.g. as CaCl₂. Any suitable amount of calcium may be added to the dairy composition. The concentration of the added calcium will usually be in the range 0.1-5.0 mM, such as between 1 and 3 mM. If CaCl₂ is added to the dairy composition the amount will usually be in the range 1-50 g per 100 liter of dairy composition, such as in the range 5-30 g per 1000 liter dairy composition, preferably in the range 10-20 g per 100 liter dairy composition.

The bacterial count of skim milk may be lowered by conventional steps. In an embodiment of the invention, the dairy composition may be subjected to a homogenization process before production of cheese, such as in the production of Danish Blue Cheese.

### Heat Treatment

It is well known that heat treatment of milk during commercial processing operations results in a number of physicochemical changes in the milk constituents. The type of changes and extent of these changes are determined by temperature of the treatment, the time of the heat treatment and the composition of the milk such as its pH, concentration of protein and fat and presence of cations like e.g. calcium and magnesium. Sometimes, a different combination of parameters can lead to the same or similar end result. For example, a short heat treatment at high temperature may have similar effects as a longer heat treatment at low temperature. It is known to the expert in the field how experimental parameters should to be changed to obtain similar end results for different processing routes, or how such routes should be established.

According to the invention the dairy composition is heat treated at an elevated temperature for a time that is preferably sufficient to cause impaired milk coagulation in the coagulation step. By heat treated milk is meant milk which is treated at a temperature of at least 75° C. for at least 1 second, preferably at least 1 minute, more preferably at leat 10 minutes. The heat treatment may be performed at a temperature of at least 75° C., preferably at least 80° C. In one embodiment the heat treatment is conducted at a temperature between 75° C. and 145° C., in a preferred embodiment the heat treatment is conducted at a temperature between 75° C. and 120° C., in a more preferred embodiment the heat treatment is conducted at a temperature between 75° C. and 100° C., in an even more preferred embodiment the heat treatment is performed between 80° C. and 90° C. The duration of the heat treatment may be any time suitable to achieve impaired milk clotting behaviour. In one embodiment the duration of the heat treatment is between 1 second and 30 minutes. In one embodiment the heat treatment is conducted at 75° C. to 90° C. degrees for 5 seconds to 30 minutes, in another embodiment the heat treatment is conducted at 80° C. to 90° C. for 2 seconds to 30 minutes, in a still further embodiment the heat treatment is conducted at 80° C. to 145° C. from 1 second to 20 minutes. The heat treatment may be conducted by any method known in the art, such as e.g. in a plate heat exchanger, by batch wise heating of the milk in a tank or container or by steam injection. Heat treatment of whey proteins, either separately, in mixture or in milk, is a well known phenomenon and has been described in literature (e.g. Mulvihill & Donovan (1987) Ir. J. Food Sci. Techn. 11, 43-75). The quantitation of whey protein denaturation can be measured by determining the loss of solubility in the isoelectric pH range or on saturation with NaCl. Another manifestation of whey protein denaturation is the increased side group reactivity, especially the sulphydryl-groups of β-lactoglobulin (Mulvihill & Donovan (1987) Ir. J. Food Sci. Techn. 11, 43-75 and references sited therein). Milk pasteurization before cheese making results in very limited whey protein denaturation, less than 20% and preferably less than 10% of denatiration. When heat treatment is more severe, the degree of denaturation will increase, as described in literature (e.g. Law & Leaver (1997) J Agric Food Chem 45, 4255-4261; Law & Leaver (2000) J Agric Food Chem 48, 672-679). In contrast to pasteurization, high heat treatment of will result in a much higher degree of whey denaturation of at least 30%, or for at least 40%, or for at least 50%, or for at least 60% or for at least 70% or even for at least 80%.

The effect of heat treatment is very sensitive the time of heating and the exact temperature. Slight variations in heating time result in variation of the properties of the heated milk. In an industrial environment, heating processes are very well controlled and standardized. Laboratory processes are more difficult to control, and small variations of e.g. the heating time may result in slight alterations of the properties of the heated milk. This results in differences of 10-20% between individual heated milk batches, depending on the property that is measured.

### Protein Hydrolysates

By protein hydrolysate is meant the product that is formed by the hydrolysis of a protein (or briefly protein hydrolysate or hydrolysed protein), or a fraction of this protein hydrolysate for example a fraction which contains soluble peptides, or a mixture of a protein hydrolysate and a fraction of the protein hydrolysate.

Protein hydrolysates can be prepared from by incubating a protein source with a single protease or a combination of proteases. Such proteases may be any type of protease including but not limited to endo-proteases, amino peptidases, carboxypeptidases or di- and tri-aminopeptidases. Also hydrolysates produced without enzymes of partly enzymatically produced are part of the present invention, for example hydrolysates can be produced using acids or a combination of acidic treatment and enzymatic treatment.

The protein source can in principle be any protein source. A preferred source is whey protein, casein protein or a mixture thereof, more preferably whey protein. A composition comprising whey protein according to the invention may be any composition comprising whey protein such as milk, cream and cheese whey. Whey derived from any cheese source may be used, including cheddar cheese, Swiss cheese, mozzarella cheese and the like. A composition comprising whey protein may be any aqueous solution comprising whey protein. The whey protein may be obtained by any method known in the art. Whey protein preparations are commercially available in several forms such as whey protein concentrates (WPC) and whey protein isolates (WPI). Examples of such commercially available preparations are BiPro (from Davisco, USA), and Lacprodan MFGM-10 or Lacprodan Alpha-10 (from Arla Foods, Denmark). Suitable protein substrates for hydrolysis also include whole milk, skimmed milk, acid casein, rennet casein, acid whey products or cheese whey products. Moreover, vegetable substrates like wheat gluten, milled barley and protein fractions obtained from, for example, soy, rice or corn are suitable substrates. An example of a suitable commercially available wheat gluten preparation is SWP-500 (Tate & Lyle, Belgium). Also hydrolysates of deamidated gluten are advantageously used in the process of the invention.

Protein hydrolysates can be prepared by contacting the protein substrate with one proteolytic enzyme or a combination of proteolytic enzymes. Preferably at least one endoprotease, more preferably at least two or more endoproteases are used. Particularly suited are the broad spectrum endo-proteases such as Alcalase and Collupuline. By broad spectrum endoprotease is meant an endoprotease which has at least three preferential cleavage sites. Examples are papain, subtilisin, pancreatine, alkaline serine protease (e.g. esperase). Also a complex enzyme mixture especially an endoprotease containing mixture can be used such as an Aspergillus orzae or an Aspergillus niger derived preparation. In case more than one protease is used, these proteases can be added to the protein substrate simultaneously. Alternatively, the proteases can be added to the protein in a predefined sequence. Optionally, the addition of the next protease is preceded by an inactivation of the protease pr proteases that were used earlier in the hydrolysis process. Such inactivation may be achieved in various ways and the method of choice depends on the protease that has to be inactivated. Inactivation treatments include but are not limited to heat treatment and a change in pH. Alternatively, commercially available hydrolysates can be used.

The degree of hydrolysis (DH) of a protein substrate is an important parameter. The DH that can be achieved for protein hydrolysate and depends on a large number of parameters, which include but are not limited to the choice for a particular protease, the time that is allowed for the hydrolysis to proceed, the reaction conditions (pH, temperature, salt concentration etc) and the pre-treatment of the protein substrate before it is subjected to hydrolysis by the protease. The DH of the hydrolysate suitable for the process according to the invention may range form 5-60, preferably from 10-45, more preferably form 15-40. The hydrolysate may contain free amino acids. Methods to determine the DH are known to the experts in the field, e.g. the OPA-method described by Dambmann, C. Improved method for determining food protein degree of hydrolysis Journal of Food Science 2001, 66, 642-646.

The hydrolysates can be further processed in various ways, methods including but not limited to spray drying, ultrafiltration, freeze drying, vacuum drying. After drying, the dry material may be grinded and/or sieved in order to obtain fractions of a particular particle size range. Compounds may be added to the hydrolysate to facilitate drying or to influence the final characteristics of the dried hydrolysate such as its tendency to form lumps or its wettability.

Peptides

A “peptide” or “oligopeptide” is defined herein as a chain of at least two amino acids that are linked through peptide bonds. The terms “peptide” and “oligopeptide” are considered synonymous (as is commonly recognized) and each term can be used interchangeably as the context requires. A “polypeptide” is defined herein as a chain comprising of more than 30 amino acid residues. All (oligo)peptide and polypeptide formulas or sequences herein are written from left to right in the direction from amino-terminus to carboxy-terminus, in accordance with common practice.

A peptide consisting of 2 to 5 amino acids is preferred. Advantageously peptides having a net negative charge at pH 6.5 are used in the process of the invention. This net negative charge is mediated by the presence of one or more negatively charged amino acids side chains. So also amino acids which are negatively charged because of for example glycosylation and/or phosphorylation, are very useful in the process of the present invention. Preferably at least one of the amino acids of the peptide is a Glu (Glutemate) or Asp (Aspartate).

Peptides that comprise Lys (lysine), Arg (Arginine) or His (histidine) are less suitable. However peptides that contain the Lys-Lys residue surprisingly showed good results in the present process. Especially the dipeptide Lys-Lys in advantageously used. In case of a mixture of peptides is used, preferably at least 20 mol % of the peptides comprises Glu and/or Asp.

The amino acids sequence of the peptide is preferably also present in milk protein, preferably in casein. So the peptide can be produced by hydrolysing casein to form the peptide. The peptide can also be produced synthetically.

Also a mixture of peptides can be used or a mixture of a hydrolysate and one or more peptides can be used.

In general at least 0.3 mM and preferably at least 0.6 mM of the peptide is present in the milk in the process of the present invention. Preferably at least 0.3 mM and preferably at least 0.6 mM of the peptide consisting of 2 to 5 amino acids is present in the milk in the process of the present invention. In the case of more than one peptide is added, the sum of the peptides in the milk will in general be at least 0.3 mM and preferably at least 0.6 mM of peptides is present. Also hydrolysates added in an amount of at least 0.3 mM of peptides, preferably at least 0.3 mM of peptides consisting of 2 to 5 amino acids, to the milk are preferred.

### Proteolytic Enzymes

Proteins can be regarded hetero-polymers that consist of amino acid building blocks connected by a peptide bond. The repetitive unit in proteins is the central alpha carbon atom with an amino group and a carboxyl group. Except for glycine, a so-called amino acid side chain substitutes one of the two remaining alpha carbon hydrogen atoms. The amino acid side chain renders the central alpha carbon asymmetric. In general, in proteins the L-enantiomer of the amino acid is found. The following terms describe the various types of polymerized amino acids. Peptides are short chains of amino acid residues with defined sequence. Although there is not really a maximum to the number of residues, the term usually indicates a chain which properties are mainly determined by its amino acid composition and which does not have a fixed three-dimensional conformation. The term polypeptide is usually used for the longer chains, usually of defined sequence and length and in principle of the appropriate length to fold into a three-dimensional structure. Protein is reserved for polypeptides that occur naturally and exhibit a defined three-dimensional structure. In case the proteins main function is to catalyze a chemical reaction it usually is called an enzyme. Proteases are the enzymes that catalyze the hydrolysis of the peptide bond in (poly)peptides and proteins.

Under physiological conditions proteases catalyse the hydrolysis of the peptide bond. The International Union of Biochemistry and Molecular Biology (1984) has recommended to use the term peptidase for the subset of peptide bond hydrolases (Subclass E.C 3.4.). The terms protease and peptide hydrolase are synonymous with peptidase and may also be used here. Proteases comprise two classes of enzymes: the endo-peptidases and the exo-peptidases, which cleave peptide bonds at points within the protein and remove amino acids sequentially from either N or C-terminus respectively. Proteinase is used as a synonym for endo-peptidase. The peptide bond may occur in the context of di-, tri-, tetra-peptides, peptides, polypeptides or proteins. In general the amino acid composition of natural peptides and polypeptides comprises 20 different amino acids, which exhibit the L-configuration (except for glycine which does not have a chiral centre). However the proteolytic activity of proteases is not limited to peptides that contain only the 20 natural amino acids. Peptide bonds between so-called non-natural amino acids can be cleaved too, as well as peptide bonds between modified amino acids or amino acid analogues. Some proteases do accept D enantiomers of amino acids at certain positions. In general the remarkable stereo-selectivity of proteases makes them very useful in the process of chemical resolution. Many proteases exhibit interesting side activities such as esterase activity, thiol esterase activity and (de)amidase activity. These side activities are usually not limited to amino acids only and might turn out to be very useful in bioconversions in the area of fine chemicals.

Eukaryotic microbial proteases have been reviewed by North (1982). More recently, Suarez Rendueles and Wolf (1988) have reviewed the S. cerevisiae proteases and their function.

Apart from the hydrolytic cleavage of bonds, proteases may also be applied in the formation of bonds. Bonds in this aspect comprise not only peptide and amide bonds but also ester bonds. Whether a protease catalyses the cleavage or the formation of a particular bond does in the first place depend on the thermodynamics of the reaction. An enzyme such as a protease does not affect the equilibrium of the reaction. The equilibrium is dependent on the particular conditions under which the reaction occurs. Under physiological conditions the thermodynamics of the reactions is in favour of the hydrolysis of the peptide due to the thermodynamically very stable structure of the zwitterionic product. By application of physical-chemical principles to influence the equilibrium, or by manipulating the concentrations or the nature of the reactants and products, or by exploiting the kinetic parameters of the enzyme reaction it is possible to apply proteases for the purpose of synthesis of peptide bonds. The addition of water miscible organic solvents decreases the extent of ionisation of the carboxyl component, thereby increasing the concentration of substrate available for the reaction. Biphasic systems, water mimetics, reverse micelles, anhydrous media, or modified amino and carboxyl groups to invoke precipitation of products are often employed to improve yields. When the proteases with the right properties are available the application of proteases for synthesis offers substantial advantages. As proteases are stereo-selective as well as regio-selective, sensitive groups on the reactants do usually not need protection and reactants do not need to be optically pure. As conditions of enzymatic synthesis are mild, racemization and decomposition of labile reactants or products can be prevented. Apart from bonds between amino acids, also other compounds exhibiting a primary amino group, a thiol group or a carboxyl group may be linked by properly selected proteases. In addition esters, thiol esters and amides may be synthesized by certain proteases. Protease have been shown to exhibit regioselectively in the acylation of mono, di- and tri-saccharides, nucleosides, and riboflavin. Problems with stability under the sometimes harsh reaction conditions may be prevented by proper formulation. Encapsulation and immobilisation do not only stabilise enzymes but also allow easy recovery and separation from the reaction medium. Extensive crosslinking, treatment with aldehydes or covering the surface with certain polymers such as dextrans, polyethyleneglycol, polyimines may substantially extend the lifetime of the biocatalyst.

The selectivity of limited proteolysis appears to reside more directly in the proteinase-substrate interaction. Specificity may be derived from the proteolytic enzyme which recognizes only specific amino acid target sequences. On the other hand, it may also be the result of selective exposure of the ‘processing site’ under certain conditions such as pH, ionic strength or secondary modifications, thus allowing an otherwise non-specific protease to catalyse a highly specific event. The activation of vacuolar zymogens by limited proteolysis gives an example of the latter kind.

Four major classes of proteases are known and are designated by the principal functional groups in their active site: the ‘serine’, the ‘thiol’ or ‘cysteine’, the ‘aspartic’ or ‘carboxyl’ and the ‘metallo’ proteases. A detailed state of the art review on these major classes of proteases, minor classes and unclassified proteases can be found in Methods in Enzymology part 244 and 248 (A. J. Barrett ed, 1994 and 1995).

Apart from the catalytic machinery of proteases another important aspect of proteolytic enzymes is the specificity of proteases. The specificity of a protease indicates which substrates the protease is likely to hydrolyze. The twenty natural amino acids offer a large number of possibilities to make up peptides. Eg with twenty amino acids one can make up already 400 dipeptides and 800 different tripeptide, and so on. With longer peptides the number of possibilities will become almost unlimited. Certain proteases hydrolyze only particular sequences at a very specific position. The interaction of the protease with the peptide substrate may encompass one up to ten amino acid residues of the peptide substrate. With large proteinacious substrates there may be even more residues of the substrate that interact with the proteases. However this likely involves less specific interactions with protease residues outside the active site binding cleft. In general the specific recognition is restricted to the linear peptide, which is bound in the active site of the protease.

The nomenclature to describe the interaction of a substrate with a protease has been introduced in 1967 by Schechter and Berger (Biochem. Biophys. Res. Com., 1967, 27, 157-162) and is now widely used in the literature. In this system, it is considered that the amino acid residues of the polypeptide substrate bind to so-called sub-sites in the active site. By convention, these sub-sites on the protease are called S (for sub-sites) and the corresponding amino acid residues are called P (for peptide). The amino acid residues of the N-terminal side of the scissile bond are numbered P3, P2, P1 and those residues of the C-terminal side are numbered P1′, P2′, P3′. The P1 or P1′ residues are the amino acid residues located near the scissile bond. The substrate residues around the cleavage site can then be numbered up to P8. The corresponding sub-sites on the protease that complement the substrate binding residues are numbered S3, S2, S1, S1′, S2′, S3′, etc, etc. The preferences of the sub-sites in the peptide binding site determine the preference of the protease for cleaving certain specific amino acid sequences at a particular spot. The amino acid sequence of the substrate should conform with the preferences exhibited by the sub-sites. The specificity towards a certain substrate is clearly dependant both on the binding affinity for the substrate and on the velocity at which subsequently the scissile bond is hydrolysed. Therefore the specificity of a protease for a certain substrate is usually indicated by its kcat/Km ratio, better known as the specificity constant. In this specificity constant kcat represents the turn-over rate and Km is the dissociation constant.

Apart from amino acid residues involved in catalysis and binding, proteases contain many other essential amino acid residues. Some residues are critical in folding, some residues maintain the overall three dimensional architecture of the protease, some residues may be involved in regulation of the proteolytic activity and some residue may target the protease for a particular location. Many proteases contain outside the active site one or more binding sites for metal ions. These metal ions often play a role in stabilizing the structure. In addition secreted eukaryotic microbial proteases may be extensively glycosylated. Both N- and O-linked glycosylation occurs. Glycosylation may aid protein folding, may increase solubility, prevent aggregation and as such stabilize the mature protein. In addition the extent of glycosylation may influence secretion as well as water binding by the protein.

In principle the modular organization of larger proteins is a general theme in nature. In particular within the larger multimodular frameworks typical proteolytic modules show sizes of 100 to 400 amino acids on the average. This corresponds with the average size of most of the globular proteolytic enzymes that are secreted into the medium. As discussed above polypeptide modules are polypeptide fragments, which can fold and function as independent entities. Another term for such modules is domains. However domain is used in a broader context than module. The term domain as used herein refers usually to a part of the polypeptide chain that depicts in the three-dimensional structure a typical folding topology. In a protein domains interact to varying extents, but less extensively than do the structural elements within domains. Other terms such as subdomain and folding unit are also used in literature. As such it is observed that many proteins that share a particular functionality may share the same domains. Such domains can be recognized from the primary structure that may show certain sequence patterns, which are typical for a particular domain. Typical examples are the mononucleotide binding fold, cellulose binding domains, helix-turn-helix DNA binding motif, zinc fingers, EF hands, membrane anchors. Modules refer to those domains which are expected to be able to fold and function autonomously. A person skilled in the art knows how to identify particular domains in a primary structure by applying commonly available computer software to said structure and homologous sequences from other organisms or species.

Although multimodular or multidomain proteins may appear as a string of beads, assemblies of substantial more complex architecture have been observed. In case the various beads reside on the same polypeptide chain the beads are generally called modules or domains. When the beads do not reside on one and same polypeptide chain but form assemblies via non-covalent interactions then the term subunit is used to designate the bead. Subunits may be transcribed by one and the same gene or by different genes. The multi-modular protein may become proteolytically processed after transcription leading to multiple subunits. Individual subunits may consist of multiple domains. Typically the smaller globular proteins of 100-300 amino acids usually consist only of one domain.

In general proteases are classified according to their molecular properties or according to their functional properties. The molecular classification is based on the primary structure of the protease. The primary structure of a protein represents its amino acid sequence, which can be derived from the nucleotide sequence of the corresponding gene. Tracing extensively the similarities in the primary structures may allow for the notice of similarities in catalytic mechanism and other properties, which even may extend to functional properties. The term family is used to describe a group of proteases that show evolutionary relationship based on similarity between their primary structures. The members of such a family are believed to have arisen by divergent evolution from the same ancestor. Within a family further sub-grouping of the primary structures based on more detailed refinement of sequence comparisons results in subfamilies. Classification according to three-dimensional fold of the proteases may comprise secondary structure, tertiary structure and quarternary structure. In general the classification on secondary structure is limited to content and gross orientation of secondary structure elements. Similarities in tertiary structure have led to the recognition of superfamilies or clans. A superfamily or a clan is a group of families that are thought to have common ancestry as they show a common 3-dimensional fold. In general tertiary structure is more conserved than the primary structure. As a consequence similarity of the primary structure does not always reflect similar functional properties. In fact functional properties may have diverged substantially resulting in interesting new properties. At present quarternary structure has not been applied to classify various proteases. This might be due to a certain bias of the structural databases towards simple globular proteases. Many proteolytic systems that are subject to activation, regulation, or complex reaction cascades are likely to consist of multiple domains or subunits. General themes in the structural organization of such protease systems may lead to new types of classification.

In absence of sequence information proteases haven been subject to various type of functional classification. The classification and naming of enzymes by reference to the reactions which are catalyzed is a general principle in enzyme nomenclature. This approach is also the underlying principle of the EC numbering of enzymes (Enzyme Nomenclature 1992 Academic Press, Orlando). Two types of proteases (EC 3.4) can be recognized within Enzyme Nomenclature 1992, those of the exo-peptidases (EC 3.4.11-19) and those of the endo-peptidases (EC 3.4.21-24, 3.4.99). Endo-peptidases cleave peptide bonds in the inner regions of the peptide chain, away from the termini. Exo-peptidases cleave only residues from the ends of the peptide chain. The exo-peptidases acting at the free N-terminus may liberate a single amino acid residue, a dipeptide or a tripeptide and are called respectively amino peptidases (EC 3.4.11), dipeptidyl peptidases (EC 3.4.14) and tripeptidyl peptidase (EC 3.3.14). Proteases starting peptide processing from the carboxyl terminus liberating a single amino acid are called carboxy peptidase (EC 3.4.16-18). Peptidyl-dipeptidases (EC 3.4.15) remove a dipeptide from the carboxyl terminus. Exo- and endo-peptidase in one are the dipeptidases (EC 3.4.13), which cleave specifically only dipeptides in their two amino acid halves. Omega peptidases (EC 3.4.19) remove terminal residues that are either substituted, cyclic, or linked by isopeptide bonds

Apart from the position where the protease cleaves a peptide chain, for each type of protease a further division is possible based on the nature of the preferred amino acid residues in the substrate. In general one can distinguish proteases with broad, medium and narrow specificity. Some proteases are simply named after the specific proteins or polypeptides that they hydrolyze, e.g. keratinase, collagenase, elastase. A narrow specificity may pin down to one particular amino acid or one particular sequence which is removed or which is cleaved respectively. When the protease shows a particular preference for one aminoacid in the P1 or P1′ position the name of this amino acid may be a qualifier. For example prolyl amino peptidase removes proline from the amino terminus of a peptide (proline is the P1 residue). X-Pro or proline is used when the bond on the amino side of the proline is cleaved (proline is P1′ residue), eg proline carboxypeptidase removes proline from the carboxyl terminus. Prolyl endopeptidase (or Pro-X) cleaves behind proline while proline endopeptidase (X-Pro) cleaves in front of a proline. Amino acid residue in front of the scissile peptide bond refers to the amino acid residue that contributes the carboxyl group to the peptide bond. The amino acids residue behind the scissile peptide bond refers to the amino acid residue that contributes the amino group to the peptide bond. According to the general convention an amino acid chain runs from amino terminus (the start) to the carboxyl terminus (the end) and is numbered accordingly. Endo proteases may also show clear preference for a particular amino acid in the P1 or P1′ position, eg glycyl endopeptidase, peptidyl-lysine endopeptidase, glutamyl endopeptidase. In addition proteases may show a preference for a certain group of amino acids that share a certain resemblance. Such a group of preferred amino acids may comprise the hydrophobic amino acids, only the bulky hydrophobic amino acids, small hydrophobic, or just small amino acids, large positively charged amino acids, etc, etc. Apart from preferences for P1 and P1′ residues also particular preferences or exclusions may exist for residues preferred by other subsites on the protease. Such multiple preferences can result in proteases that are very specific for only those sequences that satisfy multiple binding requirements at the same time. In general it should be realized that protease are rather promiscuous enzymes. Even very specific protease may cleave peptides that do not comply with the generally observed preference of the protease. In addition it should be realized that environmental conditions such as pH, temperature, ionic strength, water activity, presence of solvents, presence of competing substrates or inhibitors may influence the preferences of the proteases. Environmental condition may not only influence the protease but also influence the way the proteinacious substrate is presented to the protease.

Proteases can be subdivided on the basis of their catalytic mechanism. It should be understood that for each catalytic mechanism the above classification based on specificity leads to further subdivision for each type of mechanism. Four major classes of proteases are known and are designated by the principal functional group in the active site: the serine proteases (EC 3.4.21 endo peptidase, EC 3.4.16 carboxy peptidase), the thiol or cysteine proteases (EC 3.4.22 endo peptidase, EC 3.4.18 carboxy peptidase), the carboxyl or aspartic proteases (EC 3.4.23 endo peptidase) and metallo proteases (EC 3.4.24 endo peptidase, EC 3.4.18 carboxy peptidase). There are characteristic inhibitors of the members of each catalytic type of protease. These small inhibitors irreversibly modify an amino acid residue of the protease active site. For example, the serine protease are inactivated by Phenyl Methane Sulfonyl Fluoride (PMSF) and Diisopropyl Fluoro Phosphate (DFP), which react with the active Serine whereas the chloromethylketone derivatives react with the Histidine of the catalytic triad. Phosphoramidon and 1,10 Phenanthroline typically inhibit metallo proteases. Inhibition by Pepstatin generally indicates an aspartic protease. E64 inhibits thiol protease specifically. Amastatin and Bestatin inhibit various aminopeptidases. Substantial variations in susceptibility of the proteases to the inhibitors are observed, even within one catalytic class. To a certain extent this might be related to the specificity of the protease. In case binding site architecture prevents a mechanism based inhibitor to approach the catalytic site, then such a protease escapes from inhibition and identification of the type of mechanism based on inhibition is prohibited. Chymostation for example is a potent inhibitor for serine protease with chymotrypsin like specificity, Elastatinal inhibits elastase like serine proteases and does not react with trypsin or chymostrypsin, 4 amido PMSF (APMSF) inhibits only serine proteases with trypsin like specificity. Extensive accounts of the use of inhibitors in the classification of proteases include Barret and Salvesen, Proteinase Inhibitors, Elsevier Amstardam, 1986; Bond and Beynon (eds), Proteolytic Enzymes, A Practical Approach, IRL Press, Oxford, 1989; Methods in Enzymology, eds E. J. Barret, volume 244, 1994 and volume 248, 1995; E. Shaw, Cysteinyl proteinases and their selective inactivation, Adv Enzymol. 63:271-347 (1990)

The catalytic mechanism of a proteases and the requirement for its conformational integrity determine mainly the conditions under which the protease can be utilized. Finding the protease that performs optimal under application conditions is a major challenge. Often conditions at which proteases have to perform are not optimal and do represent a compromise between the ideal conditions for a particular application and the conditions which would suit the protease best. Apart from the particular properties of the protease it should be realized that also the presentation of a proteinacious substrates is dependant on the conditions, and as such determines also which conditions are most effective for proteolysis. Specifications for the enzyme that are relevant for application comprise for example the pH dependence, the temperature dependence, sensitivity for or the dependence of metal ions, ionic strength, salt concentration, solvent compatibility. Another factor of major importance is the specific activity of a protease. The higher the enzyme's specific activity, the less enzyme is needed for a specific conversion. Lower enzyme requirements imply lower costs and lower protein contamination levels.

The pH is a major parameter that determines protease performance in an application. Therefore pH dependence is an important parameter to group proteases. The major groups that are recognized are the acid proteases, the neutral proteases, the alkaline proteases and the high alkaline proteases. The optimum pH matches only to some extent the proteolytic mechanism, eg aspartic protease show often an optimum at acidic pH, metalloproteases and thiol proteases often perform optimal around neutral pH to slightly alkaline, serine peptidases are mainly active in the alkaline and high alkaline region. For each class exceptions are known. In addition the overall water activity of the system plays a role. The pH optimum of a protease is defined as the pH range where the protease exhibits an optimal hydrolysis rate for the majority of its substrates in a particular environment under particular conditions. This range can be narrow, e.g. one pH unit, as well as quite broad, 3-4 pH units. In general the pH optimum is also dependant on the nature of the proteinacious substrate. Both the turnover rate as well as the specificity may vary as a function of pH. For a certain efficacy it can be desirable to use the protease far from its pH optimum because production of less desired peptides is avoided. Less desired peptides might be for example very short peptides or peptides causing a bitter taste. In addition a more narrow specificity can be a reason to choose conditions that deviate from optimal conditions with respect to turnover rate. Dependant on the pH the specificity may be narrow, e.g. only cleaving the peptide chain in one particular position or before or after one particular amino acid, or broader, e.g. cleaving a chain at multiple positions or cleaving before or after more different types of amino acids. In fact the pH dependence might be an important tool to regulate the proteolytic activity in an application. In case the pH shifts during the process the proteolysis might cease spontaneously without the need for further treatment to inactivate the protease. In some cases the proteolysis itself may be the driver of the pH shift.

In applications where low temperatures are required protease may be selected with emphasis on a high intrinsic activity at low to moderate temperature. As under such conditions inactivation is relatively slow, under these conditions activity might largely determine productivity. In processes where only during a short period protease activity is required, the stability of the protease might be used as a switch to turn the protease off. In such case more labile instead of very thermostable protease might be preferred.

Other environmental parameters which may play a role in selecting the appropriate protease may be its sensitivity to salts. The compatibility with metal ions which are found frequently at low concentrations in various natural materials can be crucial for certain applications. In particular with metallo proteases certain ions may replace the catalytic metal ion and reduce or even abolish activity completely. In some applications metal ions have to be added on purpose in order to prevent the washout of the metal ions coordinated to the protease. It is well known that for the sake of enzyme stability and life-time, calcium ions have to be supplied in order to prevent dissociation of protein bound calcium.

A comprehensive review on the biological properties and evolution of proteases has been published in van den Hombergh: Thesis Landbouwuniversiteit Wageningen: An analysis of the proteolytic system in Aspergillus in order to improve protein production ISBN 90-5485-545-2, which is hereby incorporated by reference herein.

### Protein Hydrolysates and Effect on Milk Clotting Behavior of High Heated Milk

In the examples, described below, whey protein is digested with various proteases and the resulting hydrolysates are tested for their ability to improve the impaired clotting behavior of high heated milk to form cheese. The data illustrate that some hydrolysates are able to improve clotting behavior significantly whereas other have no or little effect. The examples serve are for illustration purposes. The approach, described in this application, allows the identification of other protein hydrolysates that have the same or similar effects as the effective protein hydrolysates described in the examples. Such hydrolysates may be prepared from whey protein, but could alternatively be prepared from other protein materials, derived from sources such as but not limited to cows milk, soy, wheat, corn, pea, potato and egg. The examples describe specific proteases, which are intended to illustrate the approach but are not limiting the use of alternative proteases to prepare protein hydrolysates with the desired properties. Desired properties of the hydrolysates are the ability to reduce the clotting time of high heated milk and to increase the strength of the resulting curd.

### Formagraph

The Formagraph is an instrument designed to record coagulation properties of cheese milk. Its use as a tool to compare rennet solutions has been described (MacMahon & Brown, J Dairy Sci (1982) 65, 1639-1642). The Formagraph measurements allow the determination of three parameters during cheese making as detailed by McMahon & Brown. These are r: milk coagulation time, the time required to start gel formation, k₂₀: curd-firming time, the time between start of gel formation until a width of 20 mm is reached and a₃₀: curd firmness, the width of the graph 30 min after enzyme addition. The k₂₀ equates with a curd firmness, adequate for cutting of cheese curd. The Formagraph model 11700 (Foss Electric, Benelux) was used in the examples described below, using 87% glycerol as damper liquid. The r and k₂₀ times are expressed in mm, as measured on the recorder paper. A distance of 1 mm corresponds with a time period of 30 seconds.

### EXAMPLE 1

### Whey Protein Hydrolysis

Whey protein (Bipro from Davisco) was dissolved in water (10% w/w) and adjusted to the proper pH using HCl or NaOH. The pH was chosen depending on the protease that was used. The protein solution was treated with protease at 60° C. during 4 hours without pH control. Each protease was added 5% v/w on protein base (e.g: 5 ml protease solution per 100 g protein). In case two proteases were used, both were added at 5% w/v on protease. In both cases the PSE was added as the second enzyme 2.5 hours after addition of the first protease (subtilisin (Alcalase) or papain (Collupuline)) and incubation at 60° C., followed by another 1.5 hours incubation. Proteases were subsequently inactivated by heat treatment (85° C., 10 minutes). The pH was than adjusted to pH 5.0 using NaOH or HCl. Soluble and insoluble protein matter were separated by centrifugation and the supernatant was vacuum-dried (4 hours, 60° C.). The dried protein was crushed to a fine powder and was used for subsequent experiments. In some cases, the centrifugation step was omitted and the entire hydrolysate was vacuum dried and crushed to a fine powder.

The proteases described in table 1 were used to hydrolyze the whey protein at the indicated pH values, using the described procedure.

TABLE 1
PSE was obtained from the culture broth of Apergillus niger
as Proteases used for whey protein hydrolysis.

| Protease | Obtained from | Start pH of hydrolysis |
|---|---|---|
| Alcalase 2.4L | Novozymes | 6.5 |
| Protease SP446 | Novozymes | 6.5 |
| Fromase L2000 | DSM | 5.5 |
| PSE^{a} | | 5.0 |
| Collupuline liquid | DSM | 5.0 |
| Collupuline liquid + PSE | DSM | 5.0 |
| Alcalase + PSE | Novozymes | 6.5 |

A: PSE = Proline specific endoprotease liquid containing 10 U/ml protease. The PSE was obtained from the culture broth of Aspergillus niger as described in WO 02/45524 and units are described in WO 02/45524.

### EXAMPLE 2

### Effect of Whey Protein Hydrolysates on the Coagulation of High Heated Milk

Low heat skim milk was prepared by dissolving 11 grams of milk powder (Nilac, NIZO food research) in 100 grams of distilled water while gently stirring. This milk was heated for 10 minutes at 80° C., and cooled to 31° C. Non-heated milk was used as a reference. Milk samples were transferred to a Formagraph. Whey protein hydrolysate was added (10% on protein base: 10 gram whey protein hydrolysate per 100 g milk protein) and milk coagulation was started by the addition of coagulant (0.08 IMCU per ml, Maxiren from DSM). Clotting time (r) and curd strength (k20) were determined. Results for several hydrolysates are given in table 2.

TABLE 2
Effect of whey protein hydrolysates on clotting
times and curd strength of high heated milk.

| Protease used for whey hydrolysis | r (mm) | k20 (mm) |
|---|---|---|
| None, non-heated milk, no whey protein added | 15 | 38 |
| None, high heated milk, no whey protein added | 25 | 140 |
| Alcalase ™ (subtilisin) | 15 | 75 |
| Protease SP446 | 26 | 125 |
| Fromase L2000 | 20 | 125 |
| PSE | 24 | 125 |
| Collupuline ™ (papain) | 10 | 80 |
| Collupuline + PSE | 15 | 88 |
| Alcalase + PSE | 18 | 100 |

In the controls, no whey protein hydrolysate was added. 1 mm corresponds to 30 seconds.

The data in the table clearly demonstrate that the effect of the whey protein hydrolysate on clotting time and curd strength depends on the protease used for whey hydrolysis. Particularly suited are the broad spectrum endo-proteases such as serine protease subtilisin (Alcalase) and papain (Collupuline), both alone and in combination with PSE. They are able to reduce the clotting times of high heated milk to that of non-heated milk or even further (for collupuline). Also, the curd strength of the high heated milk is significantly improved in these cases. The highly specific proteases SP446, FromaseL2000 and PSE, under the conditions used, do not result in strong reduction of clotting times or curd strengths, hereby suggesting that the DH of the hydrolysate used is an important parameter.

### EXAMPLE 3

### Dose Dependence of the Effect of Whey Protein Hydrolysates on the Gelling Characteristics of High Heated Milk

High heated milk was clotted as described in example 2, using various doses of Collupuline digested whey protein hydrolysate. Experimental conditions and controls were as described in example 2. The results are presented in table 3.

TABLE 3
Dose dependence of effect of Collupuline-digested whey protein hydro-
lysate on milk clotting characteristics of high heated milk.

| % of hydrolysate (on protein base) | r (mm) | k20 (mm) |
|---|---|---|
| Non-heated milk, no hydrolysate added | 15 | 38 |
| High heated milk, no hydrolysate added | 25 | 140 |
| 2% | 20 | 115 |
| 5% | 16 | 105 |
| 10% | 10 | 80 |

1 mm corresponds to 30 seconds.

The results demonstrate that increasing doses of the whey protein hydrolysate lead to improved r-values and k20-values, compared to high heated milk without added hydrolysate.

### EXAMPLE 4

### Method of Preparation of Miniature Cheeses

Miniature cheeses were produced as described by Shakeel-Ur-Rehman et al. (Protocol for the manufacture of miniature cheeses in Lait, 78 (1998), 607-620). High heated (80° C., 10 minutes) cows milk was used. In some case asteurisedzed full fat homogenized milk was used directly instead of raw cows milk. The heat treated milk was transferred to wide mouth plastic centrifuge bottles (200 mL per bottle) and cooled to 31° C. Subsequently, 1.8 Units of starter culture DS 5LT1 (DSM Gist B.V., Delft, The Netherlands) were added to each of the 200 ml of pasteurized milk in the centrifuge bottles and the milk was ripened for 20 minutes. Then, CaCl₂ (132 μL of a 1 mol.L⁻¹ solution per 200 mL ripened milk) was added, followed by the addition of protein hydrolysate. Finally the coagulant was added (0.04 IMCU per ml). The milk solutions were held for 40-50 minutes at 31° C. until a coagulum was formed. The coagulum was cut manually by cutters of stretched wire, spaced 1 cm apart on a frame. Healing was allowed for 2 minutes followed by gently stirring for 10 minutes. After that, the temperature was increased gradually to 39° C. over 30 minutes under continuous stirring of the curd/whey mixture. Upon reaching a pH of 6.2 the curd/whey mixtures were centrifuged at room temperature for 60 minutes at 1,700 g. The whey was drained and the curds were held in a water bath at 36° C. The cheeses were inverted every 15 minutes until the pH had decreased to 5.2-5.3 and were then centrifuged at room temperature at 1,700 g for 20 minutes. After manufacture the cheeses were weighed.

### EXAMPLE 5

### Effect of the Addition of Dipeptides on the Gelling Characteristics of High Heated Milk

Several dipeptides were tested for their ability to improve the milk clotting properties of high heated milk (80° C., 10 minutes). Milk clotting experiments were performed as described in example 1, using full fat milk (Campina, The Netherlands) to which 1.8 mM CaCl₂ was added. The results are given in table 4.

TABLE 4
Effect of several peptides on the clotting behaviour of high heated
milk. 1 mm corresponds to 30 seconds.

| Dipeptide | Dosage (% w/v) | r (in mm) | k20 (in m) |
|---|---|---|---|
| None | — | 36 | 180 |
| Glu | 0.15 | 36 | 180 |
| Glu-Glu | 0.02 | 30 | 130 |
| Glu-Glu | 0.05 | 29 | 120 |
| Glu-Glu | 0.10 | 27 | 100 |
| Glu-Glu | 0.15 | 25 | 95 |
| Lys-Lys | 0.15 | 27 | 115 |
| Leu-Leu | 0.15 | 36 | 180 |
| Ala-Ala | 0.15 | 36 | 180 |

The results in table 4 indicate that the glu-glu-peptides, which contain negatively charged amino acid side chains at milk pH (pH6.5-6.7), give most improvement of r and k₂₀ values, compared to the situation where no peptides are added. Addition of free glutamate has no effect. The improvements are clearly dose dependent, as can be concluded for the concentration series. The lys-lys-peptide, which contain positively charged side chains at milk pH (pH6.5-6.7), also shows reduced r and k₂₀ values, but the improvement is less compared to the glu-glu-peptides at similar concentration. The Leu-Leu and Ala-Ala peptides, that contain no charged side chains, show no effect on r and k₂₀ values. Clearly, the peptides must contain a charge amino acid side chains, preferably a negative charge in order to obtain improvement in clotting characteristics.

### EXAMPLE 6

### Cheese Yield Improvement with High Heated Milk in Combination with Hydrolysates or Peptides

Miniature cheese were prepared as described in example 4, using full fat cows milk, heated at 80° C. for 10 minutes. A hydrolysate of GMP, prepared as described in example 7, was added to 0.2% (w/v) to improve clotting characteristics. In a separate experiment, the peptide glu-glu, described in example 5, was added to 0.05% instead of the hydrolysate. In the first control experiment high heated milk was used without addition of hydrolysate of peptoide. In a second control experiment, cheeses were prepared from pasteurized full fat milk instead of high heated milk. Hydrolysate or peptide was added in this control experiment to the same concentrations as used for the high heated milk. The cheeses, prepared from the high heated milk, showed normal clotting behaviour in the presence of the hydrolysate or peptide and firm miniature cheeses were obtained. In the control experiment in which no hydrolysate or peptide was added to the high heated milk, the clotting behaviour was poor and a very weak curd was formed that had poor consistency.

The cheeses, prepared from high heated milk with addition of hydrolysate or peptide showed improved cheese yield, compared to the corresponding control experiment with pasteurized milk. In case of the GMP-hydrolysate, a yield increase of 22% on wet weight was obtained; the increase on dry weight was 7%. In case of the addition of the glu-glu-peptide, the gain in wet weight was 16% and the corresponding gain in dry weight was 2%. The results indicate that addition of glu-glu peptide or the GMP-hydrolysate to high heated milk results in formation of a firm cheese curd with a substantial increase in cheese yield.

### EXAMPLE 7

### Effect of a GMP-Hydrolysate on the Gelling Characteristics of High Heated Milk

Lacprodan CGMP-10 (Arla Foods, Denmark) was dissolved in water (10% w/w) and heated to 55° C. The pH was corrected with malic acid to pH4.5, and PSE was added (4% on protein). The solution was maintained at 55° C. and stirred for 3 hours. The liquid was than heat treated (7 seconds, 130° C.), concentrated in a 10 kDa cut-off membrane and spray dried. The hydrolysate has a DH of 12%. The hydrolysate was tested for its ability to improve the milk clotting characteristics of high heated milk using the procedure described in example 2. In this experiment, full fat milk (Campina, The Netherlands), heated for 10 minutes at 80° C. for 10 minutes was used to which 1.8 mM CaCl₂ was added. The results are given in the table 5

TABLE 5
Dose dependence of effect of GMP-hydrolysate on milk
clotting characteristics of high heated milk.

| % of hydrolysate (on protein base) | r (in mm) | K20 (in mm) |
|---|---|---|
| 0.00 | 36 | 210 |
| 0.15 | 25 | 130 |
| 0.30 | 21 | 100 |

1 mm corresponds to 30 seconds.

The data in table 5 clearly demonstrate the positive effect of the hydrolysate on the clotting properties of the high heated milk. The addition of the hydrolysate results in reduced r and k20 values compared to the situation in which no hydrolysate was added. The effect of the hydrolysate is clearly dose dependent.

### EXAMPLE 8

### Effect of a Gluten Hydrolysate on the Gelling Characteristics of High Heated Milk

Deamidated gluten protein (SWP obtained from Tate and Lyle, Belgium) was digested with Flavourzyme (obtained from Novozymes, Denmark) or Accellerzyme NP50000 (ODSM, The Netherlands), principally using the procedure as described in example 1. The deamidate gluten contains a high mole percentage of glutamate residues. The hydrolysates were tested for their potential to improve the clotting characteristics of high heated (80° C., 10 minutes) full fat milk after addition of CaCl₂ to 1.8 mM in a Formagraph experiment. In a control experiment, no additions were done to the high heated milk. The results are given in table 6.

TABLE 6
Effect of the addition of SWP-hydrolysates on
the clotting properties of high heated milk.

| | DH (%) | Dosage (% w/v) | r (inm mm) | k20 (in mm) |
|---|---|---|---|---|
| Control | | | 34 | 215 |
| SWP- | 31 | 0.30 | 23 | 155 |
| Flavourzyme | | | | |
| SWP-NP50000 | 7 | 0.30 | 24 | 180 |

1 mm corresponds to 30 seconds.

Clearly, the addition of both the hydrolysates results in reduced r and k₂₀ values, as demonstrated by the figures in table 6. Clearly, the hydrolysate with the highers DH (SWP-Flavourzyme: DH:31%) gives the best improvement.

### EXAMPLE 9

### Identification of Peptides that Improve the Gelling Properties of High Heated Milk

A GMP-hydrolysate (750 mg), prepared as described in example 7, was suspended in 25 ml 0.1M NH₄Acetate (pH5.0) and centrifuged (12000 rpm, Sorvall, SA600 rotor). The clear supernatant was filtered over a 0.22 μm Millipore filter. A volume of 3 ml of this solution was loaded on a Hiload 26/60 Superdex peptide 30 pg (Pharmacia), equilibrated in 0.1M NH₄Acetate (pH5.0) and chromatographed at 2.5 ml/min; effluent was monitored at 280 nm. Fractions of 10 ml were collected and freeze dried. The freeze dried fractions were re-dissolved in the original sample volume and tested for their capability to improve the renneting behaviour of high heated milk (80° C., 10 minutes). High heated milk was coagulated following the procedure that is described in example 2, with the exception that coagulation was carried out in 96-well microtiterplates with volumes of 200 μl. The pH of the milk was monitored after all additions to identify possible deviations from the original milk pH. In case of deviations, the experiment was repeated. After addition of the peptides and the rennet, plates were incubated for 2 hours at 30° C., after which the plates were turned upside down and shaken firmly to remove not clotted milk. The clotted milk remains in the wells whereas the non-clotted milk or poorly clotted milk is removed from the wells. Fractions that were positive in this test were pooled and, after freeze drying and subjected to a second fractionation on a 3 ml Resource RPC column, equilibrated in solvent A (MilliQ water+2% acetonitril+0.065% Ttrufluoroacetic acid)). After sample application, the column was washed (3 ml/min) with 4 column volumes solvent A, after which a linear gradient of 0-50% B in A was performed. (B: 20% MilliQ, 80% acetonitril, 0.05% TFA). Fractions of 1 ml were collected, freeze dried and resolubilized in their original volume. The resolubilized fractions were tested for their capability to improve the clotting behaviour of high heated milk in the microtiter plate method, described before. The most active fractions were submitted to mass spectrometric analysis to identify peptides present. The following peptides were identified:

TABLE 7
Peptides, identified in GMP hydrolysate after fractionation.

| Peptide-sequence | Occurrence in milk proteins: |
|---|---|
| Thr-Leu-Glu | κ-casein residues 145-147 |
| Glu-Ile-Asn | κ-casein residues 158-160 |
| | αs₂ casein residues residues 84-86 |
| Ser-Gly-Glu-Pro | κ-casein residues 127-130 |
| Thr-Thr-Glu | κ-casein residues 135-137 |
| Thr-Thr-Glu-Ala | κ-casein residues 135-138 |

The identified peptides all originate from the glyco-macro-peptide (GMP), the part of κ-casein that is released from the casein micelles in milk by chymosine during cheese making. Since GMP is part of cheese whey it is expected that the same peptides can also be produced from cheese whey protein preparations.

In order to confirm that the identified peptides are responsible for the observed effects, they were synthesized and purified (Pepscan, Lelystad, The Netherlands) resulting in >90% pure preparations. The peptides were tested in the clotting of high heated milk, using the MTP-procedure described above. Several peptide concentrations were used. The results are given in table 8

TABLE 8
Effect of synthetic peptides on the clotting behaviour of high heated milk

| | Concentrations applied in | |
|---|---|---|
| Peptide | milk (mM) | Formation of firm gel |
| none | — | No |
| Thr-Leu-Glu | 2.5, 1.25, 0.62, 0.25 | Yes, except at 0.25 mM |
| Glu-Ile-Asn | 2.5, 1.25, 0.62, 0.25 | Yes, except at 0.25 mM |
| Ser-Gly-Glu-Pro | 2.5, 1.25, 0.62, 0.25 | Yes, except at 0.25 mM |
| Thr-Thr-Glu | 2.5, 1.25, 0.62, 0.25 | Yes, except at 0.25 mM |
| Thr-Thr-Glu-Ala | 2.5, 1.25, 0.62, 0.25 | Yes, except at 0.25 mM |

The results clearly confirm that the identified peptides are responsible for the improved clotting behaviour of high heated milk. Concentrations of 0.62 mM are sufficient to give the improvement, a concentration of 0.25 mM is not sufficient to obtain a firm gel. The peptides are all characterized by the presence of a glutamate residue, providing a net negative charge to the peptides at the pH of milk in the early stages of cheese making (pH 6.5-6.9).

### EXAMPLE 10

### Effect of Various Synthetic Peptides on the Clotting Behaviour of High Heated Milk

The results, described in example 9, suggested that peptides containing a negative net charge, lead to improved clotting behaviour of high heated milk. Several peptides were prepared to test this hypothesis. They were tested in the MTP-assay, described in example 9, their improving behaviour. The results are given in table 9.

TABLE 9
Effect of various synthetic peptides on the clotting behaviour of
high heated milk

| | Concentration applied in | |
|---|---|---|
| Peptide | milk (mM) | Formation of firm gel |
| None | — | No |
| Phe-Leu-Glu-Pro | 2.5, 1.25, 0.62, 0.25 | Yes, except 0.25 mM |
| Phe-Leu-Gln-Pro | 2.5, 1.25, 0.62, 0.25 | No |
| Leu-Pro-Glu | 2.5, 1.25, 0.62, 0.25 | Yes, except at 0.25 mM |
| Leu-Pro-Asp | 2.5, 1.25, 0.62, 0.25 | Yes, except at 0.25 mM |
| Leu-Pro-Ala | 2.5, 1.25, 0.62, 0.25 | No |
| Leu-Pro-Cys | 2.5, 1.25, 0.62, 0.25 | No |

The results confirm the concept, derived from example 9, that peptides containing a negative net charge are able to provide the improved clotting behaviour. The peptide phe-leu-glu-pro and phe-leu-gln-pro differ at one position only: the negatively charged glutamate (glu) is replaced with the very homologous but uncharged glutamine (gln). This replacement results in disappearance of the improving effect in milk clotting of high heated milk. It clearly demonstrates that the negative charge mediated by the glutamate, is essential to obtain the improved clotting behaviour of high heated milk. This is confirmed by the results obtained with the other peptides: replacement of the glutamate (glu) in val-pro-glu by the uncharged amino acids alanine (ala) or cysteine (cys) eliminates the effect on milk clotting. The data clearly demonstrate that small peptides, containing a glutamate or aspartate, are able to improve the milk clotting behaviour of high heated milk. The peptides are all negatively charged at the pH of milk during cheese making (pH6.5-6.9). The peptides that show a positive effect on milk clotting behaviour contain a content of negatively charged amino acids (glu, asp) of 25-33 mol % in absence of positively charged amino acids (arg, lys, his).

1. A method of producing curd or cheese from a milk composition comprising the following steps:
heating milk,
adding to the heat treated milk a protein hydrolysate, and/or a peptide and/or a mixture of peptides
adding to the heat treated milk a coagulant to form a gel, and
processing the formed gel into a cheese curd and separating the whey from the curd.

2. A method according to claim 1 whereby the protein hydrolysate is obtained from whey protein, casein or caseinate or a mixture thereof.

3. A method according to claim 1 whereby a protein hydrolysate having a degree of hydrolysis (DH) of 5 to 60 is used.

4. A method according to claim 1 whereby the peptide is a peptide comprising 2 to 5 amino acids or is a protein hydrolysate or peptide mixture which comprises a peptide comprising 2 to 5 amino acids.

5. A method according to claim 1 whereby the peptide has a net negative charge at pH 6.5 or comprises the Lys-Lys residue.

6. A method according to claim 1 whereby the peptide comprises a Glu or Asp residue and/or comprises at least 20 mol % of a Glu or Asp residue.

7. A curd which is obtainable from the method of claim 1 which comprises a protein hydrolysate and/or a peptide and/or a mixture of peptides and which has a clotting time (r) of 20 mm (corresponding to 10 minutes) or less and/or a curd strength (k20) of 100 mm or less.

8. A cheese produced from the curd of claim 7 or from a method of producing curd or cheese from a milk composition comprising:
heating milk,
adding to the heat treated milk a protein hydrolysate, and/or a peptide and/or a mixture of peptides
adding to the heat treated milk a coagulant to form a gel, and
processing the formed gel into a cheese curd and separating the whey from the curd.

9. A dairy product which comprises curd of claim 7 or cheese produced from the curd or from a method of producing curd or cheese from a milk composition comprising:
heating milk,
adding to the heat treated milk a protein hydrolysate, and/or a peptide and/or a mixture of peptides
adding to the heat treated milk a coagulant to form a gel, and
processing the formed gel into a cheese curd and separating the whey from the curd or which is produced from the curd or cheese produced from the curd or from a method of producing curd or cheese from a milk composition comprising:
heating milk,
adding to the heat treated milk a protein hydrolysate, and/or a peptide and/or a mixture of peptides
adding to the heat treated milk a coagulant to form a gel, and
processing the formed gel into a cheese curd and separating the whey from the curd.

10. Use of a hydrolysate and/or a peptide and/or a mixture of peptides to reduce the clotting time in a cheese making process whereby heat-treated milk is used.

11. Use of a hydrolysate and/or a peptide and/or a mixture of peptides to increase the curd strength of a curd in a cheese making process whereby heat-treated milk is used.

12. Use of a hydrolysate and/or peptide and/or a mixture of peptide increase the cheese yield in a cheese making process whereby heat-treated milk is used.

13. Use of a hydrolysate and/or a peptide and/or a mixture of peptides in producing a cheese prepared from heat-treated milk.

14. Use of a hydrolysate and/or a peptide and/or a mixture of peptides in producing a dairy product prepared from heat-treated milk.

15. A method according to claim 1 whereby the protein hydrolysate is obtained from whey protein.

16. A method according to claim 1 whereby a protein hydrolysate having a degree of hydrolysis (DH) of 10 to 45 is used.

17. A method according to claim 1 whereby a protein hydrolysate having a degree of hydrolysis (DH) of 15 to 40 is used.
